(19) United States
(12) Patent Application Publication
(10) Pub. No.: US 2016/0087798 A1
(43) Pub. Date: Mar. 24, 2016

(54) COMPUTATION OF HASH VALUE FOR A MESSAGE BASED ON RECEIVED PORTIONS OF THE MESSAGE

(71) Applicant: Raymond Campbell, Irvine, CA (US)

(72) Inventor: Raymond Campbell, Irvine, CA (US)

(73) Assignee: Unisys Corporation, Blue Bell, PA (US)

(21) Appl. No.: 14/494,654

(22) Filed: Sep. 24, 2014

(51) Int. Cl. H04L 9/32

(52) U.S. Cl. CPC H04L 9/3242

(57) ABSTRACT

Hash values for a message may be computed by a receiving computer as portions of the message are received. In one embodiment, an intermediate hash value is computed for a portion of the message and a new intermediate hash value computed for each received portion of the message based on a previous intermediate hash value and the contents of the new received portion. When all portions of the message have been received, the final calculated intermediate hash value is the hash value for the entire message. In one embodiment, such a method of calculating a hash value may be based on the SHA-256 hash algorithm or other known or later developed hash algorithms. In one embodiment, the hash calculation for portions of received messages may be applied to keyed-hashing for message authentication (HMAC).

### FIELD OF THE DISCLOSURE

The instant disclosure relates to computer security. More specifically, this disclosure relates to hash algorithms.

### BACKGROUND

Hash algorithms receive as input a data sequence and return as output a hash value that corresponds to the input data sequence. The hash algorithm may, for example, receive a variable size input data sequence and always return a fixed size hash value. For example, inputs “John Smith” and “Jane Doe” to a hash algorithm may generate hash values of “032” and “502,” respectively. Hash algorithms find many uses within computing systems, and particularly in data communications.

Hash algorithms may be used in data communications to generate, for example, check sum values for detecting whether there is any corruption in the data of a received message. The message “John Smith” may be transmitted from a sending computer along with the hash value “032.” When the message is received at a receiving computer, the receiving computer may compute a hash value of the received data and determine whether the computed hash value matches the transmitted hash value. If the data was corrupted during transport and the received data was “Jon Smith,” the computed hash value by the receiving computer may be “055.” The receiving computer can determine that “055” does not match the “032” and request retransmission of the data.

Hash algorithms may also be used in data communications to generate, for example, encrypted data. For encrypting data, a hash algorithm may transform an input data sequence into an encrypted data sequence with the use of a secure key. The encrypted data sequence is then transmitted from the sending computer to the receiving computer. The hash algorithm makes nearly impossible the reverse calculation of the original input data sequence from the encrypted data sequence without a copy of the secure key. Because the secure key is generally not transmitted through data communications along with the encrypted data sequence, someone who intercepts the encrypted data sequence will be unable to determine the contents of the original input data sequence.

Although the use of hash algorithms is known in the above example applications, hash algorithms conventionally operate on an entire message. However, data is often received by the receiving computer in portions, such as when a maximum packet size of the underlying data network is exceeded by the size of the input data sequence. For example, a message may be transmitted in portions as shown in FIG. 1. FIG. 1 illustrates a conventional method for computing a hash value. A message 102 may include a plurality of bits representing information contained in the message 102. When transmitted through a network interface, the plurality of bits may be divided into several portions of the message, each portion containing a subset of the original set of bits. For example, the message 102 may be divided into portions 104A-D. Each of the portions 104A-D may then be packaged and transmitted in various containers based on the underlying computer network infrastructure. When the entire message 102 is received at a receiving computer, the message 102 may be passed through a hash algorithm to calculate hash value corresponding for the message 102. However, waiting until the entire message 102 has been received results in decreased performance, because the receiving computer and the user of the receiving computer must then wait for the entire message 102 to be hashed and that process cannot begin until the entire message is received.

### SUMMARY

Hash values for a message may be computed by a receiving computer as portions of the message are received. In one embodiment, an intermediate hash value is computed for a portion of the message and a new intermediate hash value computed for each received portion of the message based on a previous intermediate hash value and the contents of the new received portion. When all portions of the message have been received, the final calculated intermediate hash value is the hash value for the entire message. In one embodiment, such a method of calculating a hash value may be based on the SHA-256 hash algorithm or other known or later developed hash algorithms. In one embodiment, the hash calculation for portions of received messages may be applied to keyed-hashing for message authentication (HMAC).

According to one embodiment, a method may include the steps of receiving a first plurality of bits representing a portion of a message; computing a first hash value based, at least in part, on a portion of the first plurality of bits; receiving a second plurality of bits representing a second portion of the message; and computing a second hash value based, at least in part, on the first hash value and at least a portion of the second plurality of bits.

According to another embodiment, a computer program product may include a non-transitory medium having code to perform the steps of receiving a first plurality of bits representing a portion of a message; computing a first hash value based, at least in part, on a portion of the first plurality of bits; receiving a second plurality of bits representing a second portion of the message; and computing a second hash value based, at least in part, on the first hash value and at least a portion of the second plurality of bits.

According to yet another embodiment, an apparatus may include a processor and a memory coupled to the processor. The processor may be configured to perform the steps of receiving a first plurality of bits representing a portion of a message; computing a first hash value based, at least in part, on a portion of the first plurality of bits; receiving a second plurality of bits representing a second portion of the message; and computing a second hash value based, at least in part, on the first hash value and at least a portion of the second plurality of bits.

According to one embodiment, a method may include the steps of receiving an authentication key for authenticating a communications session; receiving a first plurality of bits representing a portion of a message; computing a first hash value based, at least in part, on a portion of the first plurality of bits and the authentication key; receiving a second plurality of bits representing a second portion of the message; and computing a second hash value based, at least in part, on the first hash value and at least a portion of the second plurality of bits.

According to another embodiment, a computer program product may include a non-transitory medium having code to perform the steps of receiving an authentication key for authenticating a communications session; receiving a first plurality of bits representing a portion of a message; computing a first hash value based, at least in part, on a portion of the first plurality of bits and the authentication key; receiving a second plurality of bits representing a second portion of the message; and computing a second hash value based, at least in part, on the first hash value and at least a portion of the second plurality of bits.

According to yet another embodiment, an apparatus may include a processor and a memory coupled to the processor. The processor may be configured to perform the steps of receiving an authentication key for authenticating a communications session; receiving a first plurality of bits representing a portion of a message; computing a first hash value based, at least in part, on a portion of the first plurality of bits and the authentication key; receiving a second plurality of bits representing a second portion of the message; and computing a second hash value based, at least in part, on the first hash value and at least a portion of the second plurality of bits.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 illustrates a conventional method for computing a hash value.

FIG. 2 is an illustration showing computation of a hash value for portions of a message according to one embodiment of the disclosure.

FIG. 3 is a flow chart illustrating a method of computing a hash value for a message based on portions of the message according to one embodiment of the disclosure.

FIG. 4 is a block diagram illustrating computation of intermediate hash values based on received portions of a message according to one embodiment of the disclosure.

FIGS. 5A-B are flow charts illustrating one algorithm for computation of intermediate hash values based on received portions of a message according to one embodiment of the disclosure.

FIG. 5C is a flow chart illustrating one algorithm for computation of intermediate hash values with the HMAC-SHA2-256 algorithm based on received portions of a message according to one embodiment of the disclosure.

FIG. 6 is a flow chart illustrating a method of computing a hash value for a message based on portions of the message using an authentication key according to one embodiment of the disclosure.

FIG. 7 is a block diagram illustrating a computer network according to one embodiment of the disclosure.

FIG. 8 is a block diagram illustrating a computer system according to one embodiment of the disclosure.

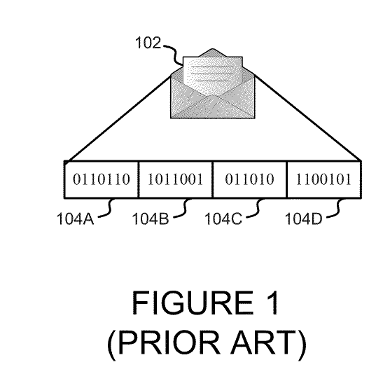

### DETAILED DESCRIPTION

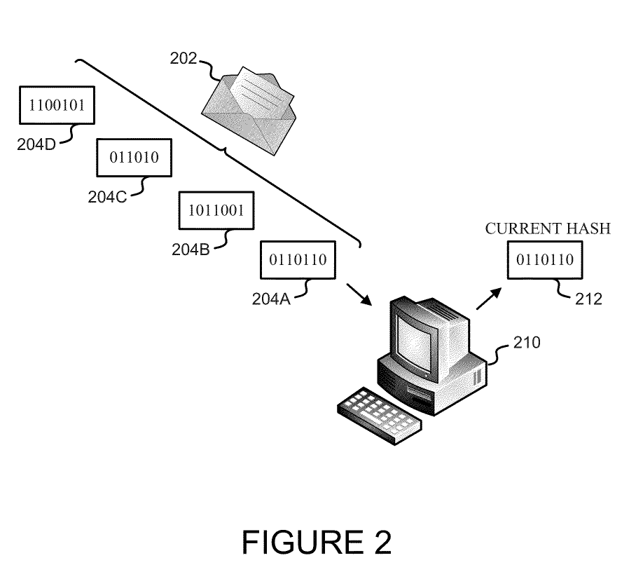

FIG. 2 is an illustration showing computation of a hash value for portions of a message according to one embodiment of the disclosure. A message 202 may be divided into portions 204A-D. Although four divisions are shown, the message 202 may be divided into more or less portions. Each of the portions 204A-D may be received at a computer 210 separately. Although the method described herein includes processing of message fragments in order, the underlying transport may reassemble out-of-order fragments before delivering them to the cryptography module executing the methods described herein. The computer 210 may store a current intermediate hash value 212 and update the value 212 after each of the portions 204A-D are received. When the entire message 202 has been received, the value of the current intermediate hash value 212 may be stored as the final hash value for the message 202.

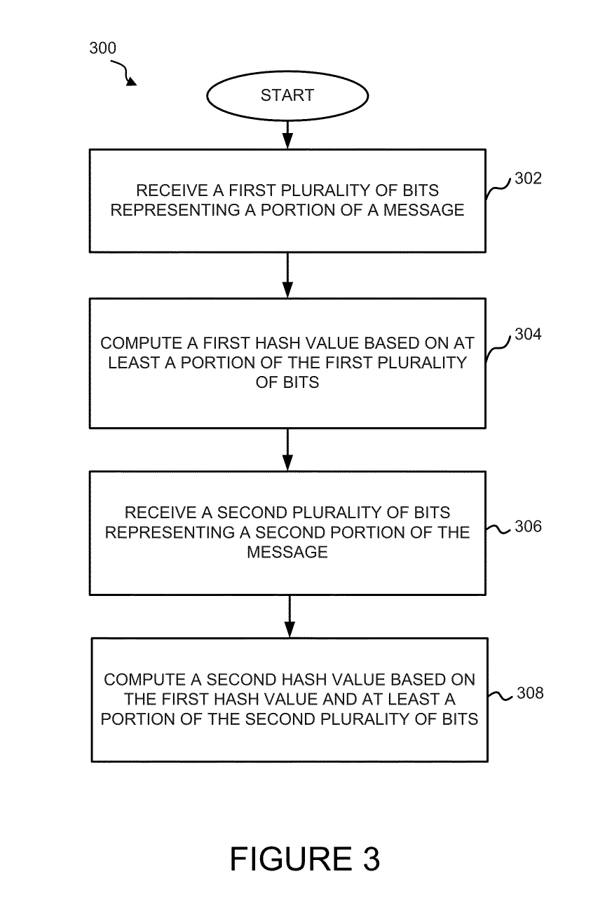

One method for processing portions of a message as shown in FIG. 2 is described with reference to the flow chart of FIG. 3. FIG. 3 is a flow chart illustrating a method of computing a hash value for a message based on portions of the message according to one embodiment of the disclosure. A method 300 begins at block 302 with a computer receiving a first plurality of bits representing a portion of a message. Then, at block 304, the computer computes a first hash value based on at least a portion of the first plurality of bits. At block 306, the computer receives a second plurality of bits representing a second portion of the message. At block 308, the computer computes a second hash value based on the first hash value and at least a portion of the second plurality of bits. When the second portion completes the message, the second hash value computed at block 308 may be the final hash value for the message. When additional portions are necessary to complete the message, additional portions may be received and the hash value updated. For example, a third plurality of bits representing a third portion of the message may be received. Then, a third hash value may be computed based on the second hash value and at least a portion of the third plurality of bits. This process may be repeated until the message is complete.

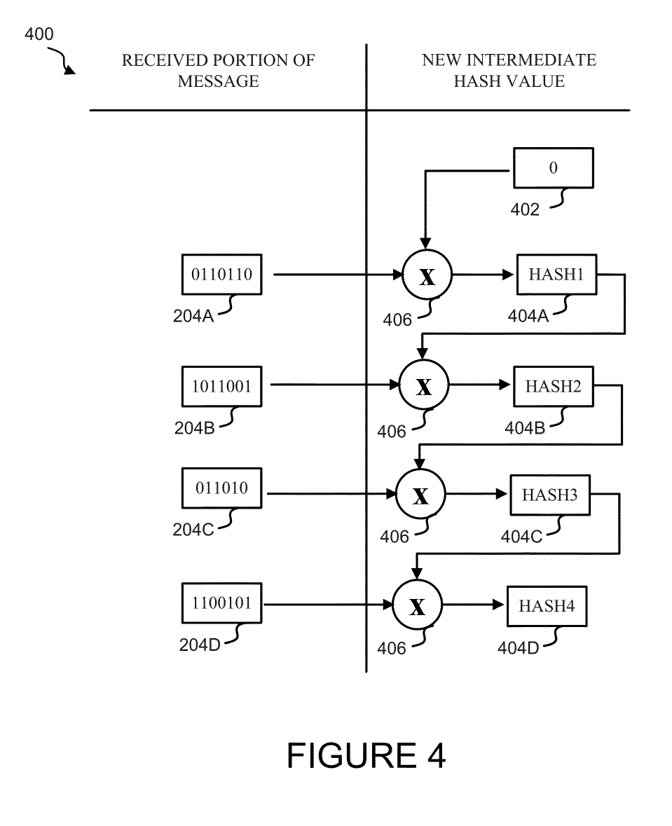

The calculation described in the flow chart of FIG. 3 is further illustrated with reference to FIG. 4. FIG. 4 is a block diagram illustrating computation of intermediate hash values based on received portions of a message according to one embodiment of the disclosure. A table 400 illustrates the calculation of an intermediate hash value while portions of a message are being received at the computer. An intermediate hash value may be initialized to a starting value, such as zero, at block 402. When a first portion 204A of the message 202 is received, that portion 204A may be supplied to an operator 406 along with the initial hash value 402. The operator 406 may perform a hash function on the combination of the portion 204A and the initial hash value 402 to obtain a first hash value HASH1 404A. In one embodiment, the operator 406 may execute the SHA-256 hash algorithm using the portion 204A and the hash value 402 as input values. Details regarding the SHA-256 hash algorithm are disclosed in the federal information processing standards publication no. 180-4 (FIPS PUB 180-4) entitled “Secure Hash Standard (SHS),” which is hereby incorporated by reference.

A second portion 204B of the message 202 may then be received. The operator 406 may again be executed to perform a hash of the combination of the portion 204B and the first hash value HASH1 404A to obtain a second hash value HASH2 404B. A third portion 204C of the message 202 may then be received. The operator 406 may again be executed to perform a hash of the combination of the portion 204C and the second hash value HASH2 404B to obtain a third hash value HASH3 404C. A fourth portion 204D of the message 202 may then be received. The operator 406 may again be executed to perform a hash of the combination of the portion 204D and the third hash value HASH3 404C to obtain a fourth hash value HASH4 404D. The computer may detect that the portion 204D completes the message 202, and thus the fourth hash value 404D may be the final hash value for the message 202. Although not described in detail here, additional operations may be performed on the fourth hash value 404D to obtain the final hash value for the message.

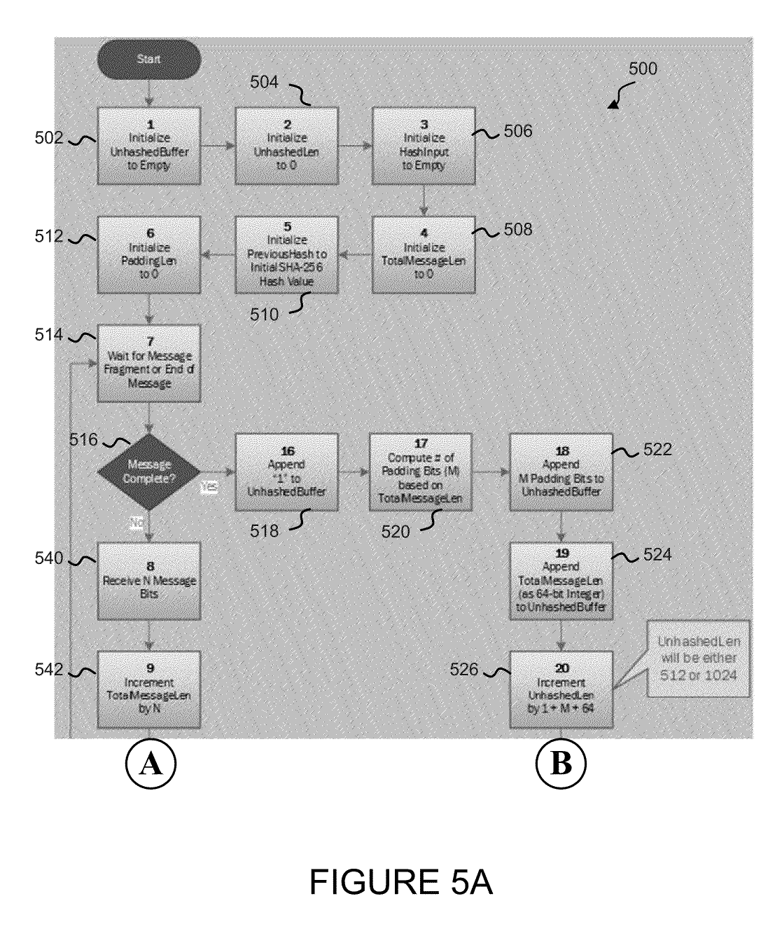

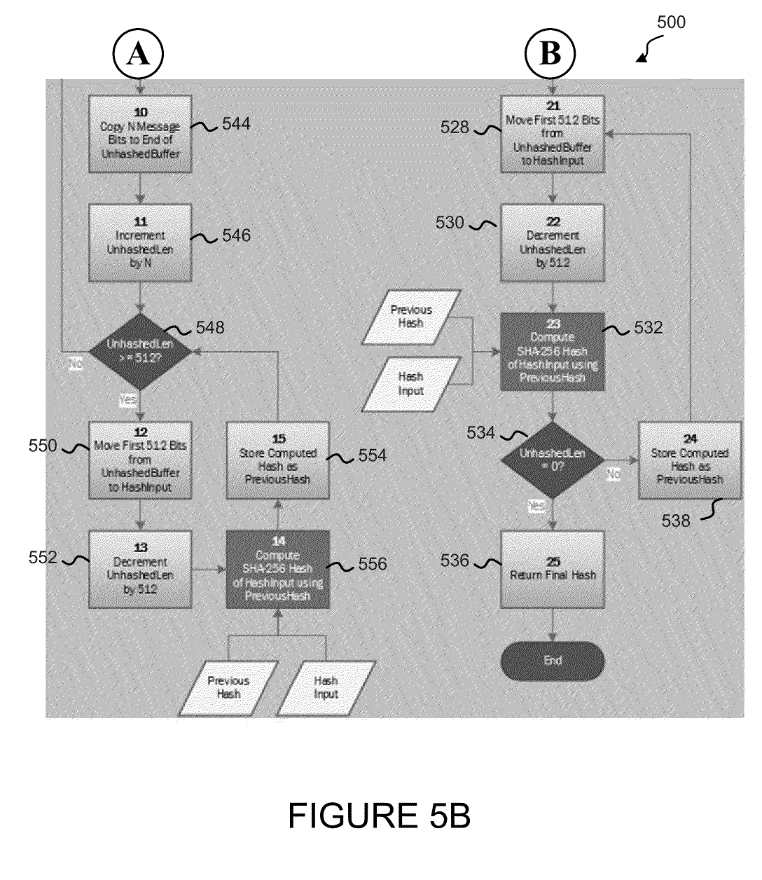

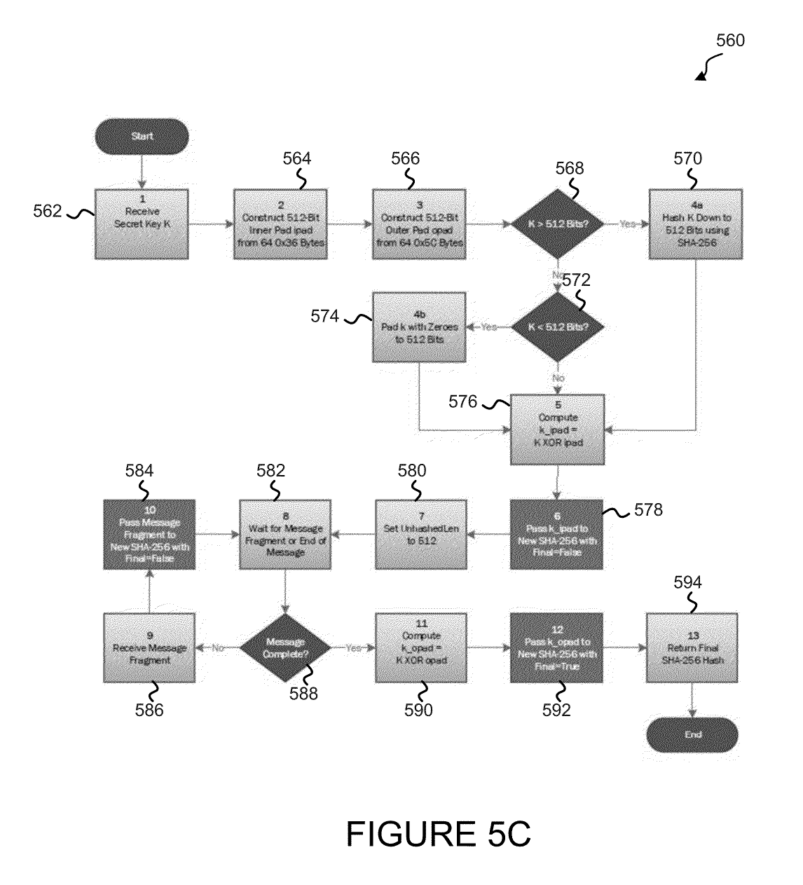

Additional operations may be performed in the execution of the algorithm described in FIG. 3 and FIG. 4. One embodiment of a method executed by a computer system to process portions of a message by computing hash values as the portions are received is described in FIGS. 5A-B. FIGS. 5A-B are flow charts illustrating one algorithm for computation of intermediate hash values based on received portions of a message according to one embodiment of the disclosure. A method 500 may begin with initialization steps 502, 504, 506, 508, 510, and 512. At block 502, an unhashed buffer may initialized, such as by allocating a portion of memory and clearing the memory. At block 504, an unhashed length variable may be initialized to zero. At block 506, a hash input may be initialized to empty. At block 508, a total message length variable may be initialized to zero. At block 510, a previous hash value may be initialized to an initial hash value based on a hash algorithm, such as SHA-256, being used. At block 512, a padding length variable may be initialized to zero.

After initialization at blocks 502, 504, 506, 508, 510, and 512, the method may continue to block 514 to wait for a portion of a message (e.g., a message fragment) to be received or for the end of the message to be detected. At block 516 it is determined whether the received portion completes the message. If the message is not complete at block 516, processing continues to block 540 to receive a plurality N of message bits and to block 542 to increment the total message length variable by N bits. Then, at block 544, the plurality N of message bits may be copied to the unhashed buffer and, at block 546, the unhashed length variable may be incremented by N bits. At block 548 it is determined whether the unhashed length is greater than a predetermined value, such as 512 bits. The determination at block 548 may allow for portions of the message to be processed in predetermined size increments. As shown in FIG. 5, the message may be processed in 512 bit increments until the message is completed. This 512 bits may include more or less than one portion of the message illustrated as portions 204A-D in FIG. 2. For example, bits for the first portion 204A and a fraction of the bits from the second portion 204B may be received and buffered before proceeding with the computation of an intermediate hash value.

If a predetermined number of bits has not been determined to be received at block 548, then the method 500 returns to block 514 to wait for additional bits or to determine if the message is complete. If a predetermined number of bits has been determined to be received at block 548, then the method 500 proceeds to block 550. At block 550, the predetermined number of bits are moved from the unhashed buffer to a hash input and, at block 552, the unhashed length variable may be decremented by the predetermined number of bits. Then, at block 556, a hash value may be computed based, at least in part, on the previous hash value and the hash input data of block 550. The hash calculated at block 556 may be stored as a previous hash value at block 554, after which the method 500 proceeds to block 548 to determine if a predetermined number of bits remain in the unhashed buffer. If there are less than the predetermined number of bits in the unhashed buffer, the method 500 returns to block 514. The method 500 may return to block 514 multiple times before enough portions of a message are received to complete the message. A parameter may be transmitted to a cryptographic interface indicating whether the current message fragment is the last message fragment

Another embodiment of the hash computation based on message fragments is shown in FIG. 5C. FIG. 5C is a flow chart illustrating one algorithm for computation of intermediate hash values with the HMAC-SHA2-256 algorithm based on received portions of a message according to one embodiment of the disclosure. A method 560 may begin at block 562 with receiving a secret key K, continue to block 564 with constructing a 512-bit inner pad (e.g., ipad) from 64 0x36 bytes, and then continue to block 566 with constructing 512-bit outerpad (e.g., opad) from 64 0x5C bytes. At block 568 it may be determined whether the key K is greater than 512 bits. If so, the method 560 continues to block 570 to compute a hash, such as with SHA-256, of the key K to obtain a value of only 512 bits. Then, the method 560 continues to block 576. If the key K was not greater than 512 bits at block 568, then the method 560 continues to block 572 to determine whether the key K is less than 512 bits. If so, the method 560 continues to block 574 to pad the key K with zeroes to reach 512 bits and continues to block 576. Thus, when the method 560 reaches block 576, the key K has a length of 512 bits, regardless of whether the key K was originally larger or smaller than 512 bits.

At block 576, a k_ipad value is computed by exclusive or-ing (XOR) the key K with the inner pad value. At block 578, the k_ipad value is passed to the SHA-256 hash algorithm with a final flag set to false. At block 580, the unhashed length is set to 512 bits. At block 582, the method 560 waits for a message fragment or end of message to be signaled. When either is received the method 560 proceeds to block 588 to determine if the message complete signal was received. If not, the message fragment is received at block 586 and the message fragment passed to the hash algorithm at block 584. When the message complete flag is received at block 588, the method 560 proceeds to block 590 to compute a k_opad value from the exclusive or of the key K and the opad value. Then, at block 592, the k_opad value is passed to the SHA-256 hash algorithm with a final flag set to true, and a final hash value is returned at block 594.

When the message is determined to be complete at block 516, the method 500 continues to block 518. At block 518, a predetermined digit, such as “1,” may be appended to the unhashed buffer. Then, at block 520, a number of padding bits M may be computed based on the total message length variable. For example, if the message is complete but there are less bits in the unhashed buffer than the predetermined amount of block 548, padding bits may be added to the unhashed buffer until the unhashed buffer has a length equal to or exceeding the predetermined amount at block 522 after taking into account additional bits that may be added in blocks 524 and 526. At block 524, the total message length value may be appended to the unhashed buffer formatted as, for example, a 64-bit integer. Then, at block 526, the unhashed length value may be incremented by 64 for the length of the message length value appended of block 524, incremented by M for the appended padding bits of block 522, and incremented by one for the digit “1” of block 518.

The method 500 continues with processing the completed message at block 528 by moving the first predetermined number of bits, such as 512 bits, from the unhashed buffer to the hash input, and subsequently decrementing the unhashed length variable by the predetermined number of bits at block 530. At block 532, a hash value is calculated based, at least in part, on the previous hash value and the hash input of block 528. It is then determined at block 534 whether the unhashed length variable is equal to zero. If so, then the computed value of block 532 is returned as the final hash value of the message at block 536. If not, then the computed hash value of block 532 is stored as the previous hash and the method 500 returns to block 528. The steps of blocks 528, 530, 532, and 534 may be repeated until a final has is obtained at block 536.

In one embodiment, when the message is complete and block 518 is reached, there may be one or two 512-bit blocks remaining to run through the hash computation at block 532. If UnhashedLen is less than 448 when the message is complete, then there are enough available bits leftover in a single 512-bit block for the “1” at block 518, the 64-bit TotalMessageLen at block 524, plus zero or more padding bits between the “1” and total message length at blocks 520 and 522. If UnhashedLen is 448 or greater when the message is complete, then an additional 512-bit block may be required and added to the message. For example, assume UnhashedLen is 432 when the message is complete. The 512-bit block will contain the following (432+1+15+64=512): the last 432 bits of the message, the “1” bit, 15 padding bits (e.g., “0”s), and the total message length as a 64-bit integer. In another example, assume UnhashedLen is 504 when the message is complete. Two 512-bit blocks may be required with the following contents (504+1+455+64=1024=512×2): the last 504 bits of the message, the “1” bit, 455 padding bits (e.g., “0”s), and the total message length as a 64-bit integer.

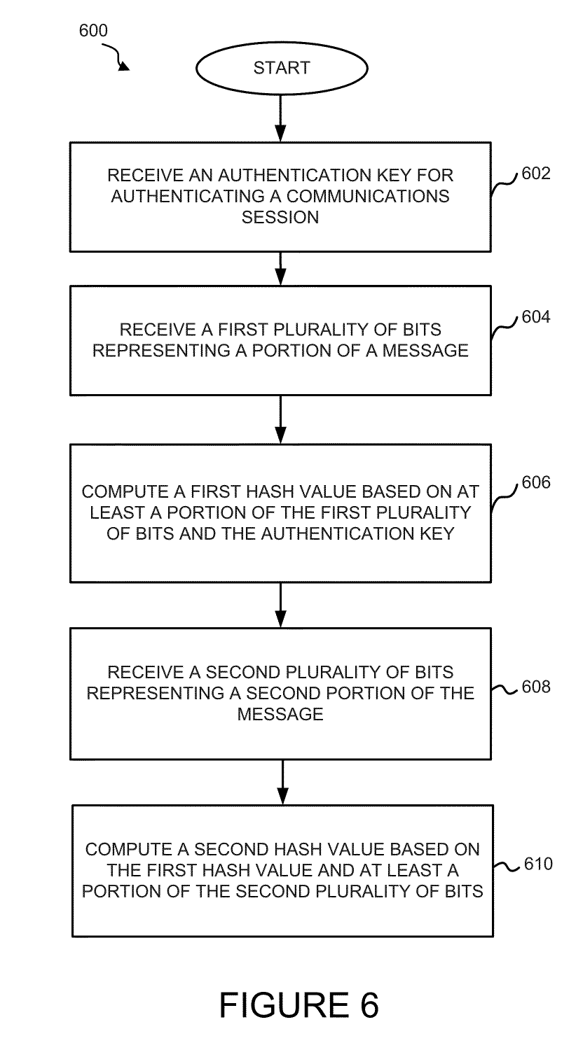

In one embodiment, the operation of hash value calculations on portions of a message as described above may be incorporated into keyed-hashing for message authentication (HMAC) by using cryptographic hash functions. With a cryptographic hash function, the has function may receive as input, in addition to the input data sequence, an authentication key. This authentication key may be, for example, a public key or a private key. One application of the above described methods to HMAC authentication is described with reference to FIG. 6. FIG. 6 is a flow chart illustrating a method of computing a hash value for a message based on portions of the message using an authentication key according to one embodiment of the disclosure. A method 600 begins at block 602 with a computer receiving an authentication key for authenticating a communications session. The key may be received, for example, from a network transmission or received from a local memory store. Then, at block 604, the computer receives a first plurality of bits representing a portion of a message. Then, at block 606, the computer computes a first hash value based on at least a portion of the first plurality of bits and the authentication key of block 602. At block 608, the computer receives a second plurality of bits representing a second portion of the message. At block 610, the computer computes a second hash value based on the first hash value and at least a portion of the second plurality of bits. In one embodiment, the second hash value may be computed by again explicitly providing the authentication key to the hash algorithm.

When the second portion completes the message, the second hash value computed at block 610 may be the final hash value for the message. When additional portions are necessary to complete the message, additional portions may be received and the hash value updated. For example, a third plurality of bits representing a third portion of the message may be received. Then, a third hash value may be computed based on the second hash value and at least a portion of the third plurality of bits. Additional details regarding implementation of HMAC are described in RFC 2104 from the Network Working Group entitled “HMAC: Keyed-Hashing for Message Authentication,” which is hereby incorporated by reference.

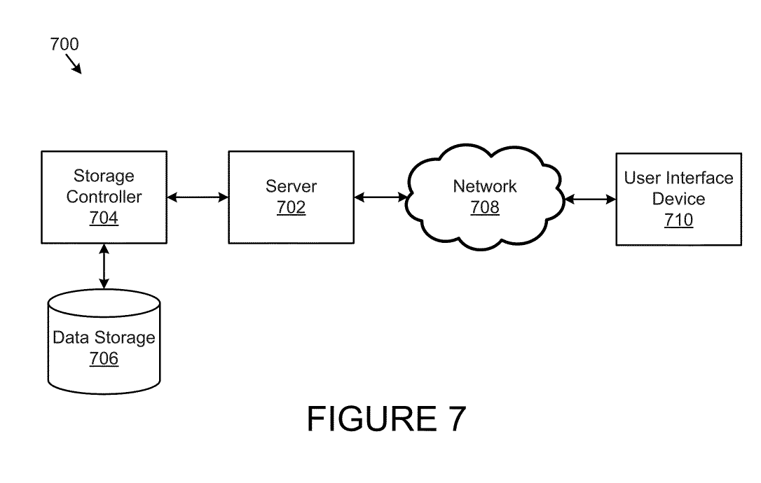

FIG. 7 illustrates one embodiment of a system 700 for an information system, including a system for computing hash values. The system 700 may include a server 702, a data storage device 706, a network 708, and a user interface device 710. In a further embodiment, the system 700 may include a storage controller 704, or storage server configured to manage data communications between the data storage device 706 and the server 702 or other components in communication with the network 708. In an alternative embodiment, the storage controller 704 may be coupled to the network 708.

In one embodiment, the user interface device 710 is referred to broadly and is intended to encompass a suitable processor-based device such as a desktop computer, a laptop computer, a personal digital assistant (PDA) or tablet computer, a smartphone, or other mobile communication device having access to the network 708. In a further embodiment, the user interface device 710 may access the Internet or other wide area or local area network to access a web application or web service hosted by the server 702 and may provide a user interface for controlling the information system.

The network 708 may facilitate communications of data between the server 702 and the user interface device 710. The network 708 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

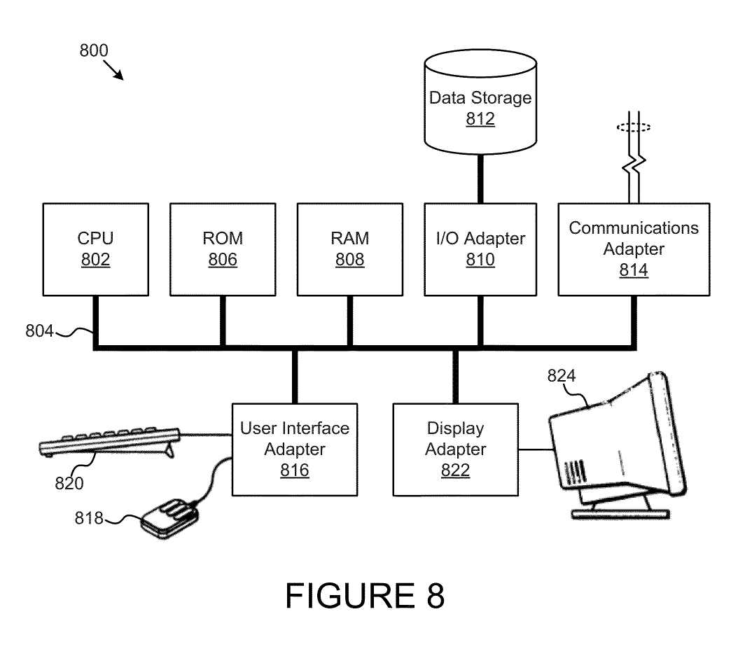

FIG. 8 illustrates a computer system 800 adapted according to certain embodiments of the server 702 and/or the user interface device 710. The central processing unit (“CPU”) 802 is coupled to the system bus 804. Although only a single CPU is shown, multiple CPUs may be present. The CPU 802 may be a general purpose CPU or microprocessor, graphics processing unit (“GPU”), and/or microcontroller. The present embodiments are not restricted by the architecture of the CPU 802 so long as the CPU 802, whether directly or indirectly, supports the operations as described herein. The CPU 802 may execute the various logical instructions according to the present embodiments.

The computer system 800 may also include random access memory (RAM) 808, which may be synchronous RAM (SRAM), dynamic RAM (DRAM), synchronous dynamic RAM (SDRAM), or the like. The computer system 800 may utilize RAM 808 to store the various data structures used by a software application. The computer system 800 may also include read only memory (ROM) 806 which may be PROM, EPROM, EEPROM, optical storage, or the like. The ROM may store configuration information for booting the computer system 800. The RAM 808 and the ROM 806 hold user and system data, and both the RAM 808 and the ROM 806 may be randomly accessed.

The computer system 800 may also include an input/output (I/O) adapter 810, a communications adapter 814, a user interface adapter 816, and a display adapter 822. The I/O adapter 810 and/or the user interface adapter 816 may, in certain embodiments, enable a user to interact with the computer system 800. In a further embodiment, the display adapter 822 may display a graphical user interface (GUI) associated with a software or web-based application on a display device 824, such as a monitor or touch screen.

The I/O adapter 810 may couple one or more storage devices 812, such as one or more of a hard drive, a solid state storage device, a flash drive, a compact disc (CD) drive, a floppy disk drive, and a tape drive, to the computer system 800. According to one embodiment, the data storage 812 may be a separate server coupled to the computer system 800 through a network connection to the I/O adapter 810. The communications adapter 814 may be adapted to couple the computer system 800 to the network 708, which may be one or more of a LAN, WAN, and/or the Internet. The user interface adapter 816 couples user input devices, such as a keyboard 820, a pointing device 818, and/or a touch screen (not shown) to the computer system 800. The keyboard 820 may be an on-screen keyboard displayed on a touch panel. The display adapter 822 may be driven by the CPU 802 to control the display on the display device 824. Any of the devices 802-822 may be physical and/or logical.

The applications of the present disclosure are not limited to the architecture of computer system 800. Rather the computer system 800 is provided as an example of one type of computing device that may be adapted to perform the functions of the server 702 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media. Additionally, the firmware and/or software may be executed by processors integrated with components described above.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving an authentication key for authenticating a communications session;
receiving a first plurality of bits representing a portion of a message;
computing a first hash value based, at least in part, on a portion of the first plurality of bits and the authentication key;
receiving a second plurality of bits representing a second portion of the message; and
computing a second hash value based, at least in part, on the first hash value and at least a portion of the second plurality of bits.

2. The method of claim 1, further comprising:
determining whether a length of the first plurality of bits exceeds a threshold length;
when the length exceeds the threshold length, then computing the first hash value; and
when the length does not exceed the threshold length, receiving an additional portion of the first plurality of bits before computing the first hash value.

3. The method of claim 1, further comprising:
determining whether the first plurality of bits and the second plurality of bits comprise an entirety of the message;
when the first and second plurality of bits do not comprise the entirety of the message, receiving a third plurality of bits representing a third portion of the message; and
when the first and second plurality of bits do comprise the entirety of the message, returning the second hash value as a final hash value for the message.

4. The method of claim 3, further comprising, when the third plurality of bits are less than a threshold number of bits, padding the third plurality of bits with a padding digit to reach the threshold number of bits.

5. The method of claim 1, further comprising:
initializing a previous hash value to an initialization value, wherein the step of computing the first hash value is based, at least in part, on the previous hash value; and
updating the previous hash value with the computed first hash value before computing the second hash value, wherein the step of computing the second hash value comprises retrieving the stored previous hash value.

6. The method of claim 1, further comprising:
storing the first plurality of bits in a buffer after receiving the first plurality of bits; and
removing the portion of the first plurality of bits from the buffer after computing the first hash value.

7. The method of claim 1, wherein the step of computing the first hash value comprises computing the first hash value using a SHA-256 algorithm.

8. A computer program product, comprising:
a non-transitory computer readable medium comprising code to perform the steps of:
receiving an authentication key for authenticating a communications session;
receiving a first plurality of bits representing a portion of a message;
computing a first hash value based, at least in part, on a portion of the first plurality of bits and the authentication key;
receiving a second plurality of bits representing a second portion of the message; and
computing a second hash value based, at least in part, on the first hash value and at least a portion of the second plurality of bits.

9. The computer program product of claim 8, wherein the medium further comprises code to perform the steps of:
determining whether a length of the first plurality of bits exceeds a threshold length;
when the length exceeds the threshold length, then computing the first hash value; and
when the length does not exceed the threshold length, receiving an additional portion of the first plurality of bits before computing the first hash value.

10. The computer program product of claim 8, wherein the medium further comprises code to perform the steps of:
determining whether the first plurality of bits and the second plurality of bits comprise an entirety of the message;
when the first and second plurality of bits do not comprise the entirety of the message, receiving a third plurality of bits representing a third portion of the message; and
when the first and second plurality of bits do comprise the entirety of the message, returning the second hash value as a final hash value for the message.

11. The computer program product of claim 10, wherein the medium further comprises code to perform the step of padding, when the third plurality of bits are less than a threshold number of bits, the third plurality of bits with a padding digit to reach the threshold number of bits.

12. The computer program product of claim 8, wherein the medium further comprises code to perform the steps of:
initializing a previous hash value to an initialization value, wherein the step of computing the first hash value is based, at least in part, on the previous hash value; and
updating the previous hash value with the computed first hash value before computing the second hash value, wherein the step of computing the second hash value comprises retrieving the stored previous hash value.

13. The computer program product of claim 8, wherein the medium further comprises code to perform the steps of:
storing the first plurality of bits in a buffer after receiving the first plurality of bits; and
removing the portion of the first plurality of bits from the buffer after computing the first hash value.

14. The computer program product of claim 8, wherein the step of computing the first hash value comprises computing the first hash value using a SHA-256 algorithm.

15. An apparatus, comprising:
a memory;
a processor coupled to the memory, wherein the processor is further configured to perform the steps of:
receiving an authentication key for authenticating a communications session;
receiving a first plurality of bits representing a portion of a message;
computing a first hash value based, at least in part, on a portion of the first plurality of bits and the authentication key;
receiving a second plurality of bits representing a second portion of the message; and
computing a second hash value based, at least in part, on the first hash value and at least a portion of the second plurality of bits.

16. The apparatus of claim 15, wherein the processor is further configured to perform the steps of:
determining whether a length of the first plurality of bits exceeds a threshold length;
when the length exceeds the threshold length, then computing the first hash value; and
when the length does not exceed the threshold length, receiving an additional portion of the first plurality of bits before computing the first hash value.

17. The apparatus of claim 15, wherein the processor is further configured to perform the steps of:
determining whether the first plurality of bits and the second plurality of bits comprise an entirety of the message;
when the first and second plurality of bits do not comprise the entirety of the message, receiving a third plurality of bits representing a third portion of the message; and
when the first and second plurality of bits do comprise the entirety of the message, returning the second hash value as a final hash value for the message.

18. The apparatus of claim 17, wherein the processor is further configured to perform the step of padding, when the third plurality of bits are less than a threshold number of bits, the third plurality of bits with a padding digit to reach the threshold number of bits.

19. The apparatus of claim 15, wherein the processor is further configured to perform the steps of:
storing the first plurality of bits in a buffer after receiving the first plurality of bits; and
removing the portion of the first plurality of bits from the buffer after computing the first hash value.

20. The apparatus of claim 15, wherein the step of computing the first hash value comprises computing the first hash value using a SHA-256 algorithm.
